(19) United States
(12) Patent Application Publication
(10) Pub. No.: US 2014/0227567 A1
(43) Pub. Date: Aug. 14, 2014

(54) BATTERY MODULE

(71) Applicant: Samsung SDI Co., Ltd., Yongin-si (KR)

(72) Inventors: Min-Yeol Han, Yongin-si (KR); Sang-Won Byun, Yongin-si (KR); Jin-Seop Kim, Yongin-si (KR); Su-Jin Yoon, Yongin-si (KR)

(73) Assignee: Samsung SDI Co., Ltd., Yongin-si (KR)

(21) Appl. No.: 13/966,017

(22) Filed: Aug. 13, 2013

Related U.S. Application Data
(60) Provisional application No. 61/764,872, filed on Feb. 14, 2013.

(51) Int. Cl. H01M 2/34

(52) U.S. Cl. CPC H01M 2/345
USPC 429/61

(57) ABSTRACT

A battery module including a battery cell including: an electrode assembly including a first electrode and a second electrode; a case housing the electrode assembly; and a short circuit member at a side of the case and electrically coupled to the second electrode is disclosed. The battery may further include a short circuit connector including a short circuit conductor electrically coupled to the first electrode, the short circuit member being spaced from the short circuit conductor and being configured to change shape to contact the short circuit conductor, and the short circuit connector having a cutout below the short circuit conductor.

### CROSS-REFERENCE TO RELATED APPLICATION

This application claims priority to and the benefit of U.S. Provisional Application No. 61/764,872, filed on Feb. 14, 2013 in the U.S. Patent and Trademark Office, the entire content of which is incorporated herein by reference.

### BACKGROUND

1. Field

Aspects of the described technology relate to a battery module for improving safety.

2. Description of the Related Art

Unlike a primary battery that cannot be recharged, a rechargeable battery may be repeatedly charged and discharged. A small-capacity rechargeable battery is used, for example, for small portable electronic devices such as mobile phones, notebook computers, camcorders, and the like, while a large-capacity rechargeable battery is used, for example, as a motor-driving power source for hybrid vehicles and electric vehicles.

The rechargeable battery may be used in small electronic devices as a single-cell battery or in a motor-driving power source, etc. as a battery module where a plurality of cells is electrically coupled. The battery module is formed by connecting electrode terminals through a bus bar.

The rechargeable battery may explode or ignite when an abnormal reaction occurs that increases the pressure in the case of a battery cell as a result of an overcharge when the battery module is charged and discharged.

The above information disclosed in this Background section is only for enhancement of understanding of the background of the described technology and therefore it may contain information that does not form the prior art that is already known in this country to a person of ordinary skill in the art.

### SUMMARY

Aspects of embodiments of the described technology are directed toward a battery module having improved safety when an internal pressure of a battery is increased in the battery module.

An embodiment of a battery module includes a battery cell including: an electrode assembly including a first electrode and a second electrode; a case housing the electrode assembly; and a short circuit member at a side of the case and electrically coupled to the second electrode. The battery module may further include a short circuit connector including a short circuit conductor electrically coupled to the first electrode, the short circuit member being spaced apart from the short circuit conductor and being configured to change shape to contact the short circuit conductor, and the short circuit connector having a cutout below the short circuit conductor.

According to aspects of an exemplary embodiment, the short circuit member is provided on the side of the case to prevent moisture from being condensed on a surface of the short circuit member (or to reduce the amount of moisture that condenses on a surface of the short circuit member). Also, in some embodiments, a module frame (e.g., a short circuit connector) including a short circuit conductor capable of electrically contacting the short circuit member is provided and installed in the direction of gravity to prevent the module frame and the short circuit member from being erroneously contacted by the condensed moisture between the short circuit member and the module frame (or to reduce the likelihood of the module frame and the short circuit member being erroneously contacted by the condensed moisture between the short circuit member and the module frame).

In some embodiments, the cutout is adapted to drain condensed moisture away from the short circuit conductor.

The short circuit conductor may include a short circuit protrusion protruding toward the short circuit member.

The battery module may further include a support protrusion on a side of the short circuit connector facing toward the battery cell to provide a gap between the short circuit protrusion and the battery cell.

The short circuit connector may further include an insulating layer at least partially wrapping the short circuit conductor. In some embodiments, the insulating layer has an opening to expose the short circuit conductor to the short circuit member.

In some embodiments, the cutout extends from the bottom of the insulating layer to the opening.

The cutout may extend through a portion of the insulating layer and through a portion of the short circuit conductor.

In some embodiments, the case has a short circuit hole, and the short circuit member is at the short circuit hole. For example, the short circuit hole may be surrounded by a groove, and the short circuit member may have a flat edge inserted into the groove.

The short circuit member may include a flat edge and a curved portion curved convexly toward the interior of the case, the curved portion being configured to be reversibly transformed to be curved concavely away from the interior of the case to contact the short circuit conductor.

In some embodiments, the short circuit member is substantially parallel to a side of the case. The short circuit member may be substantially parallel to a direction of the Earth's gravitational pull.

The second electrode and the short circuit member may be each electrically coupled to the case and the short circuit member may be configured to change shape to contact the short circuit conductor, to electrically couple the first electrode to the second electrode through the case.

In some embodiments, the battery module further includes an additional battery cell. For example, the battery cell and the additional battery cell may be in a stack, and the short circuit connector may wrap around the stack. In some embodiments, the additional battery cell includes a first electrode and a second electrode, and a first module terminal is electrically coupled to the first electrode of the additional battery cell at a first end of the stack and a second module terminal is electrically coupled to the second electrode of the battery cell at a second end of the stack.

In some embodiments, the short circuit conductor is electrically coupled to the second module terminal of the battery cell at the second end of the stack.

The additional battery cell may include a short circuit member facing the short circuit conductor.

In some embodiments, the first electrode is electrically coupled to a first electrode terminal by a first electrode lead tab and the second electrode is electrically coupled to the second electrode terminal by a second electrode lead tab, and at least one of the first electrode lead tab or the second electrode lead tab includes a fuse having a smaller cross-section than a remaining portion of the first electrode lead tab or a remaining portion of the second electrode lead tab.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery module according to a first exemplary embodiment of the present invention.

FIG. 2 is a perspective view of a rechargeable battery cell according to the first exemplary embodiment of the present invention.

FIG. 3 is a cross-sectional view with respect to a line III-III in FIG. 1.

FIG. 4 is a perspective view of a module frame according to the first exemplary embodiment of the present invention.

FIG. 5A is a circuit diagram of a battery module according to the first exemplary embodiment of the present invention, and FIG. 5B is a circuit diagram when a short circuit member electrically contacts a module frame in a battery module according to the first exemplary embodiment of the present invention.

FIG. 6 is a cross-sectional view of a battery module according to a second exemplary embodiment of the present invention.

FIG. 7 is a partial perspective view of a negative electrode lead tab according to the second exemplary embodiment of the present invention.

FIG. 8 is a partial perspective view of a positive electrode lead tab according to the second exemplary embodiment of the present invention.

FIG. 9 is a perspective view of a module frame according to the second exemplary embodiment of the present invention.

FIG. 10 is a cross-sectional view of a battery module according to a third exemplary embodiment of the present invention.

FIG. 11 is a perspective view of a module frame according to the third exemplary embodiment of the present invention.

FIG. 12 is a perspective view of a battery cell according to a fourth exemplary embodiment of the present invention.

FIG. 13 is a cross-sectional view of a battery module according to the fourth exemplary embodiment of the present invention.

FIG. 14 is a perspective view of a short circuit conductor according to a fifth exemplary embodiment of the present invention.

FIG. 15 is a cross-sectional view of a battery module according to the fifth exemplary embodiment of the present invention.

FIG. 16 is a perspective view of a short circuit conductor according to a sixth exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Also, in the context of the present application, when a first element is referred to as being “on” a second element, it can be directly on the second element or be indirectly on the second element with one or more intervening elements interposed therebetween. Like reference numerals designate like elements throughout the specification.

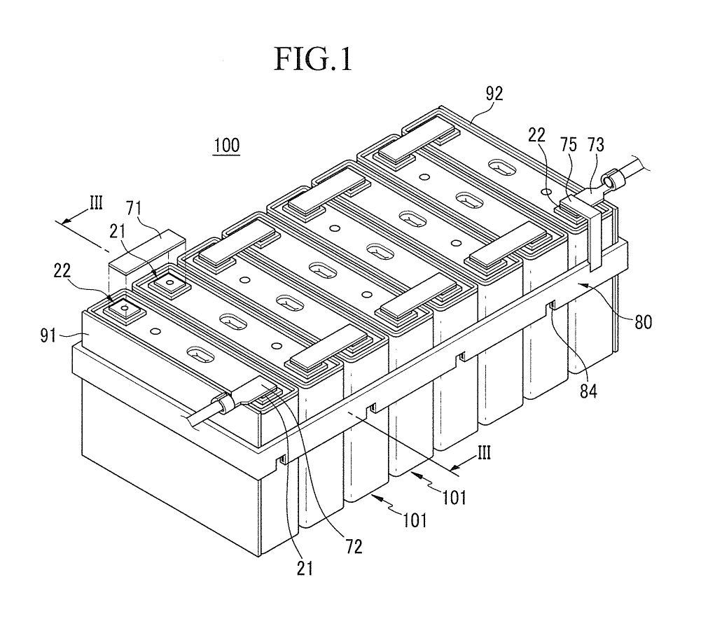

FIG. 1 is a perspective view of a battery module according to a first exemplary embodiment of the present invention.

Referring to FIG. 1, the battery module 100 includes a plurality of rechargeable batteries (e.g., a battery cell and one or more additional battery cells) 101, a bus bar 71 for electrically coupling (or electrically connecting) a first electrode terminal 21 and a second electrode terminal 22 of neighboring rechargeable batteries 101, and a module frame 80 for surrounding an external circumference of the rechargeable batteries 101, the module frame including a short circuit connector.

The rechargeable batteries (or battery cells) 101 are arranged to be stacked (e.g., as a stack), the rechargeable batteries 101 including first electrode terminals 21 and second electrode terminals 22, and when the first electrode terminals 21 and the second electrode terminals 22 are alternately disposed with respect to one another, the bus bar 71 is welded to be combined to the terminals to couple (e.g., electrically couple) the rechargeable batteries 101 in series. In some embodiments, the short circuit connector wraps around the stack.

A first module terminal 72 for drawing out a current (e.g., an electric current) is installed at the first electrode terminal 21 of the rechargeable battery 101 at a side end of a first end of the stack of rechargeable batteries 101, and a second module terminal 73 for drawing out the current (e.g., the electric current) is installed at the second electrode terminal 22 of the rechargeable battery disposed at a side end of a second end of the stack.

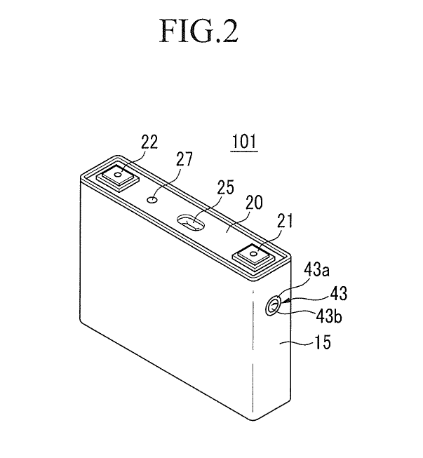

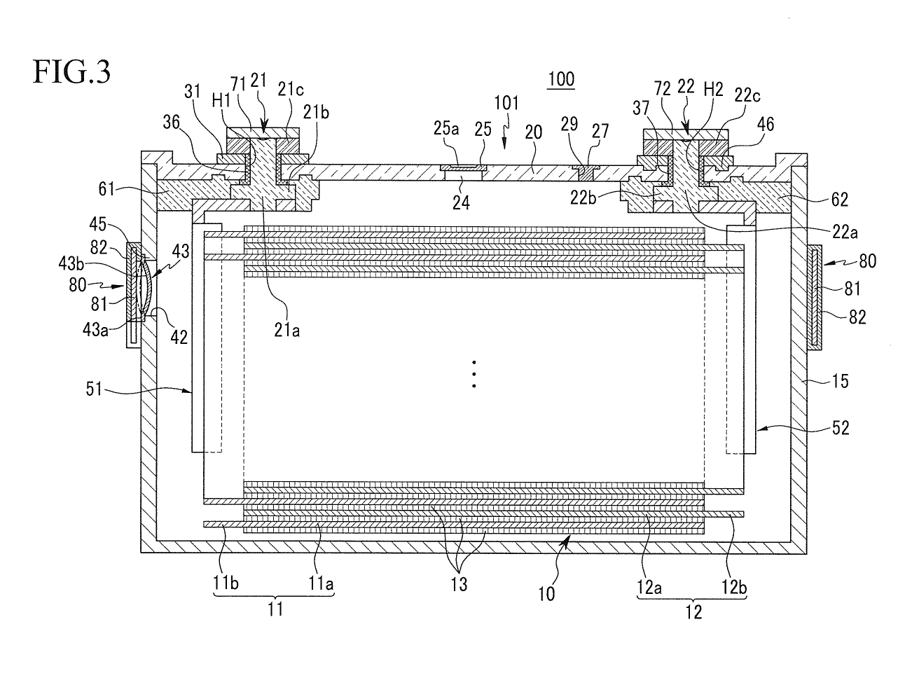

FIG. 2 is a perspective view of a rechargeable battery according to the first exemplary embodiment of the present invention, and FIG. 3 is a cross-sectional view with respect to a line III-III of FIG. 1.

Referring to FIG. 2 and FIG. 3, each rechargeable battery 101 includes an electrode assembly 10 for charging and discharging the current (e.g., the electric current), a case 15 housing the electrode assembly 10, a cap plate 20 at (e.g., combined to) an opening of the case 15, and a first electrode terminal (e.g., a negative terminal) 21 and a second electrode terminal (e.g., a positive electrode terminal) 22 at (e.g., installed in) the cap plate 20.

For example, the electrode assembly 10 is formed when a first electrode (hereinafter, a negative electrode) 11 and a second electrode (hereinafter, a positive electrode) 12 are at (e.g., disposed on) both sides of a separator 13, which is an insulator, and the negative electrode 11, the separator 13, and the positive electrode 12 are spirally wound in a jellyroll.

The negative electrode 11 and the positive electrode 12 include coated regions 11a and 12a including active material (e.g., regions that are formed by applying an active material to a current collector on a metal plate) and uncoated regions 11b and 12b that do not include an active material (e.g., regions that are formed to be exposed current collectors without application of the active material thereto).

The uncoated region 11b of the negative electrode 11 is formed at an end of the negative electrode 11 along the spirally wound negative electrode 11. The uncoated region 12b of the positive electrode 12 is formed at another end of the positive electrode 12 along the spirally wound positive electrode 12. The uncoated regions 11b and 12b are at opposite ends of the electrode assembly 10.

For example, the case 15 is cuboidal so as to have a space for receiving the electrode assembly 10 and an electrolyte solution, and an opening at one side of the cuboid for connecting an outside and an inner space of the cuboid. The opening allows the electrode assembly 10 to be inserted inside the case 15.

The cap plate 20 is at (e.g., installed in) the opening of the case 15 to close and seal the case 15. For example, the case 15 and the cap plate 20 can be made of aluminum and be welded to each other.

Also, the cap plate 20 includes an electrolyte injection opening 29, a vent hole 24, and terminal holes H1 and H2. The electrolyte injection opening 29 communicates between the outside of the cap plate 20 and the inside of the case 15 to allow the electrolyte solution to be injected into the case 15. When the electrolyte solution is injected, the electrolyte injection opening 29 is sealed with a sealing stopper 27.

The vent hole 24 is closed and sealed by a vent plate 25 capable of discharging an internal pressure of the rechargeable battery 101. When the internal pressure of the rechargeable battery 101 reaches a predetermined (or preselected or set) pressure, the vent plate 25 is incised to open the vent hole 24. The vent plate 25 includes a notch 25a for generating an incision.

The first electrode terminal 21 and the second electrode terminal 22 are installed in the terminal holes H1 and H2 of the cap plate 20 and are electrically coupled (e.g., electrically connected) to the electrode assembly 10. That is, the first electrode terminal 21 is electrically coupled to the negative electrode 11 of the electrode assembly 10, and the second electrode terminal 22 is electrically coupled to the positive electrode 12 of the electrode assembly 10. Therefore, the electrode assembly 10 is electrically coupled to the outside of the case 15 through the first electrode terminal 21 and the second electrode terminal 22.

The first electrode terminal 21 and the second electrode terminal 22 have the same (or substantially the same) configuration inside the cap plate 20, but they have different configurations outside the cap plate 20, which will now be described in more detail.

The first and second electrode terminals 21 and 22 include rivet terminals 21a and 22a, respectively, installed in the respective terminal holes H1 and H2 of the cap plate 20. Flanges 21b and 22b are each widely formed (e.g., formed to be wider than remaining portions of the respective first and second electrode terminals 21 and 22) as a single body on the rivet terminals 21a and 22a inside the cap plate 20, respectively, and plate terminals 21c and 22c are located outside the cap plate 20 and connected to the rivet terminals 21a and 22a, respectively, through riveting or welding.

Negative and positive electrode gaskets 36 and 37 are between (e.g., installed between) the respective rivet terminals 21a and 22a of the first and second electrode terminals 21 and 22 and the inside surfaces (e.g., insides) of the terminal holes H1 and H2 of the cap plate 20 to seal and electrically insulate respective spaces between the rivet terminals 21a and 22a of the first and second electrode terminals 21 and 22 and the cap plate 20.

The negative and positive electrode gaskets 36 and 37 are extended to be between (e.g., installed between) the flanges 21b and 22b and the inside surface (e.g., inside) of the cap plate 20 to further seal and electrically insulate the space between the flanges 21b and 22b and the cap plate 20. That is, the negative and positive electrode gaskets 36 and 37 prevent an electrolyte solution from being leaked (or reduce the likelihood of the electrolyte solution being leaked) through the terminal holes H1 and H2 by installing the first and second electrode terminals 21 and 22 in the cap plate 20.

Negative and positive electrode lead tabs 51 and 52 electrically couple the first and second electrode terminals 21 and 22, respectively, to the negative and positive electrodes 11 and 12 of the electrode assembly 10. That is, the negative and positive electrode lead tabs 51 and 52 are combined to respective bottoms of the rivet terminals 21a and 22a, and the bottoms are caulked so that the negative and positive electrode lead tabs 51 and 52 are supported by the flanges 21b and 22b, respectively, and are connected to the rivet terminals 21a and 22a.

Negative and positive electrode insulating members 61 and 62 are installed between the negative and positive electrode lead tabs 51 and 52, respectively, and the cap plate 20 to electrically insulate the negative and positive electrode lead tabs 51 and 52 from the cap plate 20. Further, the negative and positive electrode insulating members 61 and 62 are coupled to (e.g., combined to) the cap plate 20 on a first end and wrap each of the negative and positive electrode lead tabs 51 and 52, the rivet terminals 21a and 22a, and the flanges 21b and 22b, respectively, thereby stabilizing their connection structure (e.g., stabilizing the connections of each of the foregoing components).

The plate terminal 21c of the first electrode terminal 21 is electrically coupled (e.g., electrically connected) to the rivet terminal 21a to secure (or provide) an insulating member 31, and the plate terminal 21c is then disposed outside the cap plate 20.

The insulating member 31 is between (e.g., installed between) the plate terminal 21c and the cap plate 20 to electrically insulate the plate terminal 21c and the cap plate 20 from one another. That is, the cap plate 20 maintains electrical insulation from the first electrode terminal 21 (e.g., the cap plate 20 is electrically insulated from the first electrode terminal 21).

A top plate 46 of the second electrode terminal 22 electrically couples (e.g., electrically connects) the plate terminal 22c of the second electrode terminal 22 and the cap plate 20. For example, the top plate 46 is between (e.g., is provided between) the plate terminal 22c and the cap plate 20 and penetrates the rivet terminal 22a.

Therefore, the top plate 46 and the plate terminal 22c are coupled to (e.g., combined to) the top of the rivet terminal 22a to caulk the top so the top plate 46 and the plate terminal 22c are coupled to (e.g., combined to) the top of the rivet terminal 22a. The plate terminal 22c is located (e.g., installed) outside of the cap plate 20 when the top plate 46 is provided.

A short circuit hole 42 is formed on a side of a first end of the case 15, and a short circuit member 43 is at (e.g., installed in) the short circuit hole 42. The short circuit hole 42 is located at (e.g., formed on) the side of the case 15 that is near the first electrode terminal 21. The present invention is not restricted to the above description, and the short circuit member 43 can be located at (e.g., formed on) the side of the case 15 that is near the second electrode terminal 22.

In this instance, the side of the case 15 represents a surface that goes in (e.g., is oriented in) the same (or substantially the same) direction when the cases 15 are stacked so that the wide side surfaces (e.g., extending in a width direction of each battery cell 101) of the cases 15 face each other.

A groove 45 extended to an outer side (e.g., edge) of the short circuit hole 42 is at (e.g., formed on) the outer side (e.g.,) of the short circuit hole 42, and the groove 45 is connected to the outer side of the case 15. The short circuit member 43 is inserted into the short circuit hole 42 to stand in parallel with (e.g., is substantially parallel to) the side of the case 15. The short circuit member 43 has a plate shape and includes a flat edge 43a and a curved portion 43b curved convexly toward the inside of the case 15 at the edge 43a. The edge 43a is inserted into the groove 45, welded to the case 15, and electrically coupled (e.g., electrically connected) to the case 15. The case 15 is electrically charged to the positive polarity, and the short circuit member 43 is also electrically charged to the positive polarity.

When the rechargeable battery 101 stands so that the first and second electrode terminals 21 and 22 face upwards, the short circuit member 43 stands in the direction of gravity (e.g., the short circuit member is substantially parallel to a direction of the Earth's gravitational pull). The short circuit member 43 is electrically coupled (e.g., electrically connected) to the short circuit connector, which is electrically charged to the negative polarity, by a reversible transformation. For example, the short circuit member may be configured to change shape to contact the short circuit connector (e.g., to be electrically coupled to the short circuit connector). In the present exemplary embodiment, the short circuit connector is formed with the module frame 80 (e.g., the module frame 80 includes the short circuit connector).

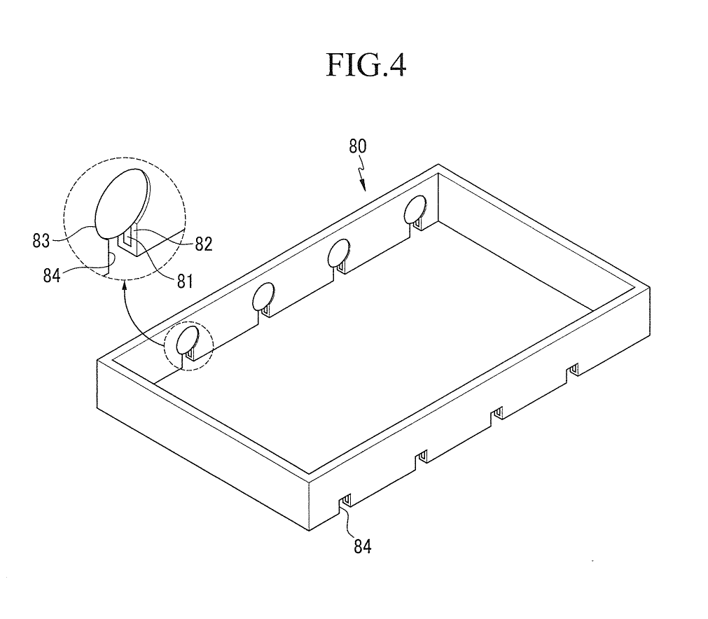

FIG. 4 is a perspective view of a module frame according to the first exemplary embodiment of the present invention.

An end plate 91 (see FIG. 1) is disposed on the rechargeable battery 101 disposed on the side end of the first end of the stack of rechargeable batteries 101, and an end plate 92 (see FIG. 1) is disposed on the side end of the second end. Also, the module frame 80 is disposed to wrap the rechargeable batteries 101 (e.g., the stack of battery cells) and the end plates 91 and 92. The module frame 80 is formed to have a rectangular shape (e.g., a square shape) disposed to face the side of the rechargeable battery 101, and partially wraps an external circumference of the rechargeable battery 101.

As can be seen in FIG. 4, the module frame 80 includes a short circuit conductor 81 including (e.g., made of) a material having electrical conductivity and an insulating layer 82 (e.g., an electrically insulating layer) wrapping (or at least partially wrapping) the short circuit conductor 81. The short circuit conductor 81 includes (e.g., is made of) an electrically conductive metal and is continuously disposed along a length direction of the module frame 80. The insulating layer 82 is formed to wrap (or at least partially wrap) the short circuit conductor 81, and an opening 83 (e.g., a portion without an insulating layer 82) is formed in the module frame 80. The opening 83 is formed at a part of the module frame 80 to face the short circuit member 43 so that the short circuit conductor 81 is exposed to directly face the short circuit member 43.

A cutout 84 is provided on the module frame 80 below the short circuit conductor 81 (e.g., extended to the bottom of the module frame 80). The cutout 84 extends from the exposed short circuit conductor 81 to the bottom of the module frame 80, and it has a predetermined (or preselected or set) width. For example, the cutout 81 may extend from a bottom of the insulating layer 82 to the opening 83. In some embodiments, the cutout extends through a portion of the insulating layer 82 and through a portion of the short circuit conductor 81. When the cutout 84 is formed (e.g., present), moisture condensed at the exposed short circuit conductor 81 can be drawn down along the cutout 84. For example, the cutout 84 may be adapted to drain condensed moisture away from the short circuit conductor 81.

Also, the module frame 80 is electrically coupled to the first electrode terminal 21 of the rechargeable battery 101 disposed to the outermost part of the stack (e.g., at a second end of the stack) with an intermediate connecting member 75 as a medium. The intermediate connecting member 75 is electrically coupled to the first electrode terminal 21 combined to the second module terminal 73.

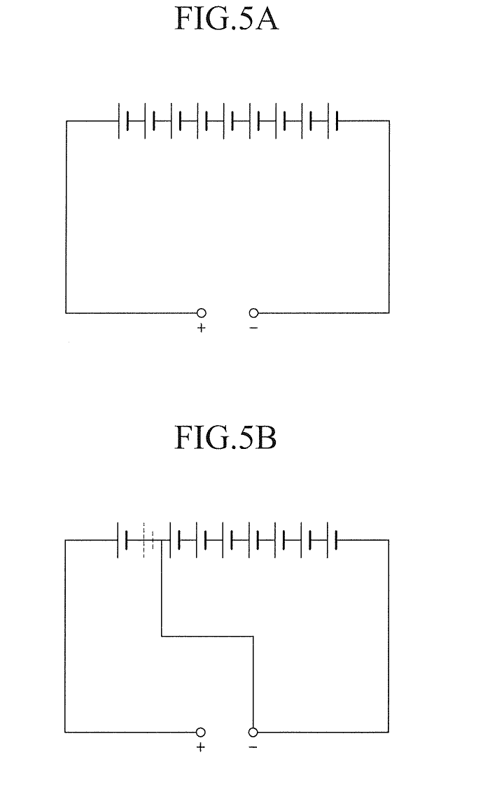

FIG. 5A is a circuit diagram of a battery module according to the first exemplary embodiment of the present invention, and FIG. 5B is a circuit diagram when a short circuit member electrically contacts a module frame in a battery module according to the first exemplary embodiment of the present invention (e.g., when a short circuit condition exists).

As shown in FIG. 5A, before the short circuit member 43 is operated, the rechargeable batteries 101 are coupled in series.

When an internal pressure of the rechargeable battery 101 is increased, the short circuit member 43 is reversibly transformed to be convex toward the outer side (e.g., the short circuit member 43 may be configured to be reversibly transformed to be curved concavely away from an interior of the case 15), and when the short circuit member 43 is reversibly transformed, the short circuit member 43 is electrically coupled to the module frame 80. For example, the short circuit member 43 may be configured to change shape to contact the short circuit connector 81. The short circuit conductor 81 may be electrically coupled to the second module terminal 73 at the second end of the stack. The second electrode 12 and the short circuit member may each be electrically coupled to the case 15, and the short circuit member 43 may be configured to change shape to contact the short circuit conductor to electrically couple the first electrode to the second electrode through the case 15. Hence, in the short circuit condition, the case 15 electrically charged to the positive polarity is electrically coupled to the module frame 80 and electrically charged to the negative polarity.

As shown in FIG. 5B, when the case 15 of the rechargeable battery installed in the second time (e.g., the battery cell at a second position of the stack) is electrically coupled to the module frame 80, a short circuit is generated to discharge a current, and the current is drawn out to the second module terminal 73 through the module frame 80. The current does not flow to the rechargeable battery (or batteries) 101 located (e.g., installed) after the short-circuited rechargeable battery 101, since the current is bypassed through the module frame 80.

According to the present exemplary embodiment, a short circuit occurs by a contact of the module frame 80 and the short circuit member 43 so no current flows to the rechargeable battery (or batteries) 101 located (e.g., installed) after the short circuit is generated and therefore safety is improved.

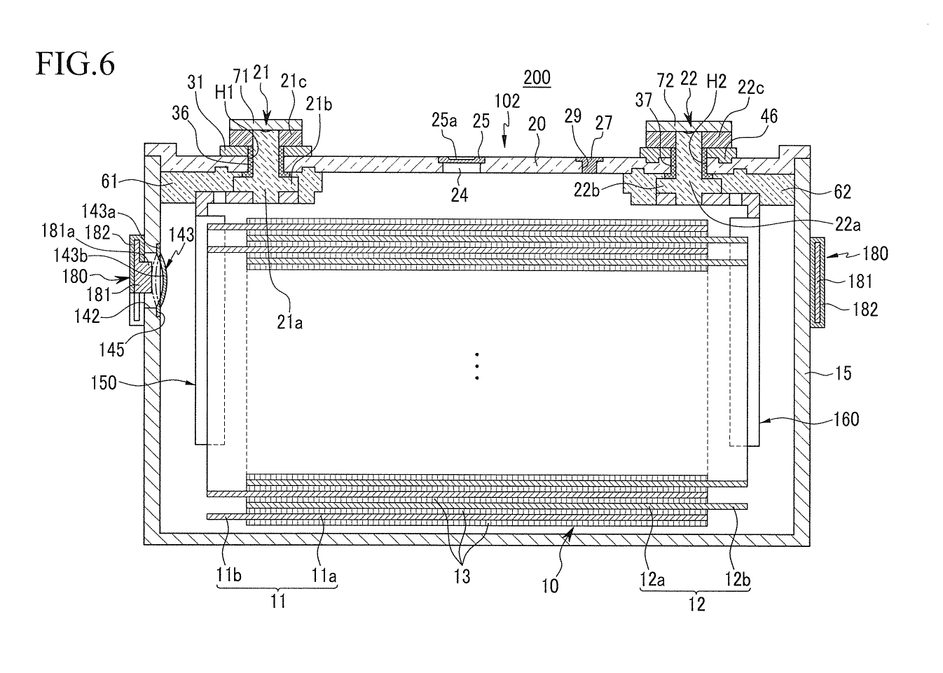

FIG. 6 is a cross-sectional view of a battery module according to a second exemplary embodiment of the present invention.

Referring to FIG. 6, the battery module 200 includes a plurality of rechargeable batteries 102 (e.g., a battery cell and one or more additional battery cells), a bus bar 71 for electrically coupling first electrode terminals 21 and second electrode terminals 22 of the neighboring rechargeable batteries 102, and a module frame 180 wrapping external circumferences of the rechargeable batteries 102 (e.g., wrapping around a stack including the rechargeable batteries 102).

The rechargeable batteries 102 are stacked, and the rechargeable batteries 102 include the first electrode terminals 21 and the second electrode terminals 22. While the first electrode terminals 21 and the second electrode terminals 22 are alternated (e.g., alternately disposed), the bus bar 71 is bonded to the terminals of the rechargeable batteries 102 through welding, and the rechargeable batteries 102 are coupled in series.

Each rechargeable battery 102 includes an electrode assembly 10 including a first electrode (negative electrode) 11 and a second electrode (positive electrode) 12, a case 15 receiving the electrode assembly 10, a cap plate 20 combined to an opening of the case 15, and a first electrode terminal 21 and a second electrode terminal 22 located (e.g., installed) in the cap plate 20.

The rechargeable battery 102 according to the second exemplary embodiment has the same (or substantially the same) configuration as the rechargeable battery according to the first exemplary embodiment except for an installation configuration of a short circuit member 143 and the configuration of a negative electrode lead tab 150 (e.g., a first electrode lead tab) and a positive electrode lead tab 160 (e.g., a second electrode lead tab) so repeated description of the features and configurations that are the same (or substantially the same) as those of the first exemplary embodiment will be omitted here.

The negative electrode lead tab 150 electrically couples the first electrode terminal 21 to the first electrode 11 of the electrode assembly 10, and the positive electrode lead tab 160 electrically couples the second electrode terminal 22 to the second electrode 12 of the electrode assembly 10.

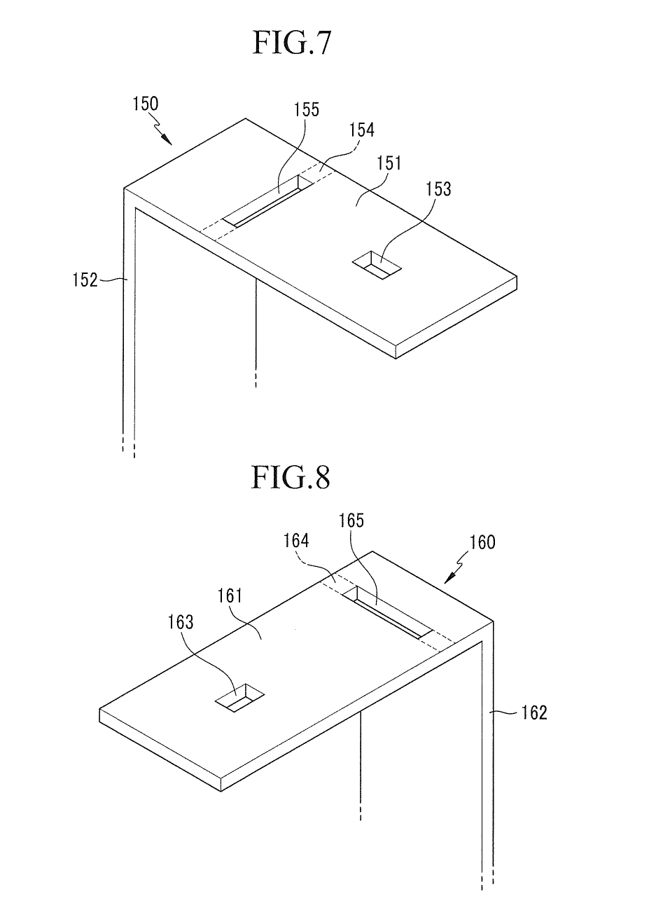

As shown in FIG. 7, the negative electrode lead tab 150 (e.g., the first electrode lead tab) includes a terminal connecting portion 151, which may be attached to the first electrode terminal 21 through welding, and an electrode connecting portion 152, which may be bent and at (e.g., formed at) the terminal connecting portion 151 and attached to the negative electrode 11 through welding. A support hole 153 into which a bottom of a rivet terminal 21a is inserted is at (e.g., formed at) the terminal connecting portion 151, and the rivet terminal 21a and the negative electrode lead tab 150 are bonded through welding. Further, a fuse 154 that has a smaller cross-section than other parts of the negative electrode lead tab 150 (e.g., a remaining portion of a first electrode lead tab) and is transformed (e.g., melted) when an overcurrent (e.g., an excessive electric current) flows to the negative electrode lead tab 150.

A fuse hole 155 is at (e.g., formed in) the fuse 154 so that the fuse 154 has (e.g., is formed to have) a smaller cross-section than other parts (e.g., the remaining portion of the first electrode lead tab), and when flow of electric current is increased and an overcurrent exceeding a preselected (or set) current limit flows, the fuse 154 is melted to intercept (e.g., interrupt) electrical connection between the electrode assembly 10 and the first electrode terminal 21.

As shown in FIG. 8, the positive electrode lead tab 160 (e.g., the second electrode lead tab) includes a terminal connecting portion 161, which may be attached to the second electrode terminal 22 through welding, and an electrode connecting portion 162, which may be bent and at (e.g., formed at) the terminal connecting portion 161 and attached to the positive electrode 12 through welding. A support hole 163 into which a bottom of a rivet terminal 21a is inserted is at (e.g., formed at) the terminal connecting portion 161, and the rivet terminal 21a and the positive electrode lead tab 160 are bonded through welding. Further, a fuse 164 that has a smaller cross-section than other parts of the positive electrode lead tab 160 (e.g., a remaining portion of a second electrode lead tab) and is transformed (e.g., melted) when an overcurrent (e.g., an excessive electric current) flows to the positive electrode lead tab 160.

A fuse hole 165 is at (e.g., formed in) the fuse 164 so that the fuse 164 has a smaller cross-section than other parts (e.g., the remaining portion of the first electrode lead tab), and when a flow of electric current is increased and an overcurrent exceeding a preselected (or set) limit flows, the fuse 164 is melted to intercept (e.g., interrupt) electrical connection between the electrode assembly 10 and the second electrode terminal 22.

As shown in FIG. 6, a short circuit hole 142 is at (e.g., formed in) a first end of the case 15, and a short circuit member 143 is at (e.g., installed in) the short circuit hole 142. The short circuit hole 142 is at (e.g., formed on) a side of the case 15 that is near the first electrode terminal 21. However, the present invention is not restricted thereto, and the short circuit member 143 can be at (e.g., formed on) the side of the case 15 that is near the second electrode terminal 22. A groove 145 extended inside the short circuit hole 142 is at (e.g., formed in) the outer side of the short circuit hole 142, and the groove 145 is connected to the inside of the case 15.

The short circuit member 143 is inserted in the short circuit hole 142 and is installed to stand parallel to the side of the case 15. The short circuit member 43 has a plate shape and includes a flat edge 143a and a curved portion 143b that is curved in a convex manner toward the inside of the case 15 from the edge 143a. The edge 143a is inserted into the groove 145, it is welded to the case 15, which is electrically coupled to the positive electrode, and the edge 143a is electrically coupled to the case 15 so that the case 15 and the short circuit member 43 are electrically charged to the positive polarity.

As described herein, when the rechargeable battery 102 stands so that the first and second electrode terminals 21 and 22 face upwards, the short circuit member 143 is installed to stand in the gravity direction. For example, the short circuit member 143 may be substantially parallel to a direction of the Earth's gravitational pull. The short circuit member 143 is electrically coupled to the negatively charged short circuit connector by reversible transformation, as described above. In the present exemplary embodiment, the short circuit connector is configured with a module frame 180.

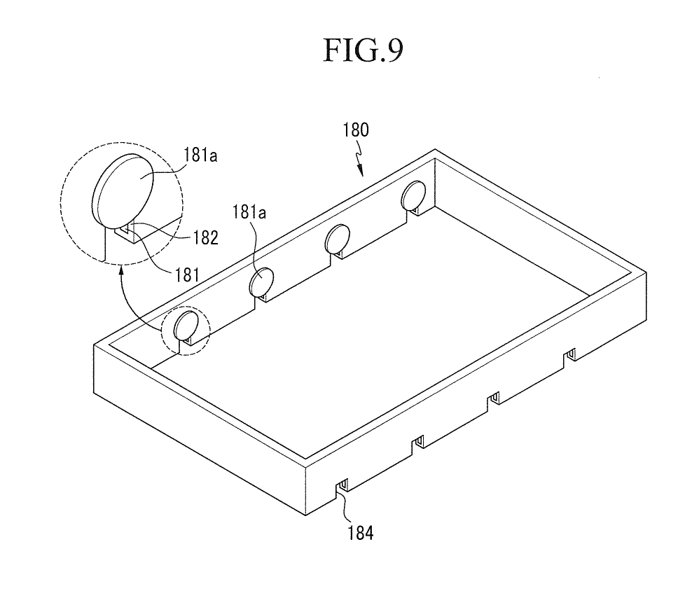

FIG. 9 is a perspective view of a module frame 180 according to the second exemplary embodiment of the present invention.

Referring to FIG. 9, the module frame 180 is formed to have a rectangular (e.g., square) shape that faces (e.g., is disposed to face) the side of the rechargeable battery 102 and wraps (or partially wraps) the external circumference of the rechargeable battery (or batteries) 102.

The module frame 180 includes a short circuit conductor 181 made of an electrically conductive material and an insulating layer 182 (e.g., an electrically insulating layer) wrapping (or partially wrapping) the short circuit conductor 181. The short circuit conductor 181 includes (e.g., is made of) an electrically conductive metal, and is continuously disposed along the length direction of the module frame 180. In a manner similar to that of the first exemplary embodiment, the short circuit conductor 181 is electrically coupled to the negative electrode.

The insulating layer 182 is formed to wrap (e.g., at least partially wrap) the short circuit conductor 181, and a short circuit protrusion 181a protruded to the outer part of the insulating layer 182 is at (e.g., formed on) the short circuit conductor 181. The short circuit protrusion 181a is at (e.g., formed on) a part of the short circuit conductor 181 that faces the short circuit member 143 so that the short circuit protrusion 181a is exposed to directly face the short circuit member 143.

In addition, a cutout 184 is at (e.g., formed on) the module frame 180 below the short circuit conductor 181 (e.g., extended to the bottom of the module frame 180). The cutout 184 extends from the bottom of the exposed short circuit protrusion 181a to reach the bottom of the module frame 180, and it has a predetermined (or preselected or set) width. In some embodiments, the cutout 184 extends through a portion of the insulating layer 182 and through a portion of the short circuit conductor 181. When the cutout 184 is formed according to the present exemplary embodiment, moisture condensed at the exposed short circuit conductor 181 can be discharged down along the cutout 184 because of gravity. For example, the cutout 184 may be adapted to drain condensed moisture away from the short circuit conductor 181.

When an internal pressure of the rechargeable battery 102 is increased, the short circuit member 143 is reversibly transformed to be convex toward the outer side (e.g., the short circuit member 143 may be configured to be reversibly transformed to be curved concavely away from an interior of the case 15), and when the short circuit member 143 is reversibly transformed, the short circuit member 143 is electrically coupled to the module frame 180. For example, the short circuit member 143 may be configured to change shape to contact the short circuit protrusion 181a. The short circuit protrusion 181a may be electrically coupled to the second module terminal 73 at the second end of the stack through the short circuit conductor 181. The second electrode 12 and the short circuit member 143 may each be electrically coupled to the case 15, and the short circuit member 143 may be configured to change shape to contact the short circuit protrusion 181a to electrically couple the first electrode to the second electrode through the case 15.

Also, as shown in FIG. 7 and FIG. 8, fuses 154 and 164 are formed on the negative electrode lead tab 150 and the positive electrode lead tab 160 so when a short circuit is generated and a large current flows, the fuses 154 and 164 are melted to intercept (or interrupt) the electric current. Hence, the rechargeable battery 102 touching a short circuit connector becomes a neutral battery and acquires safety.

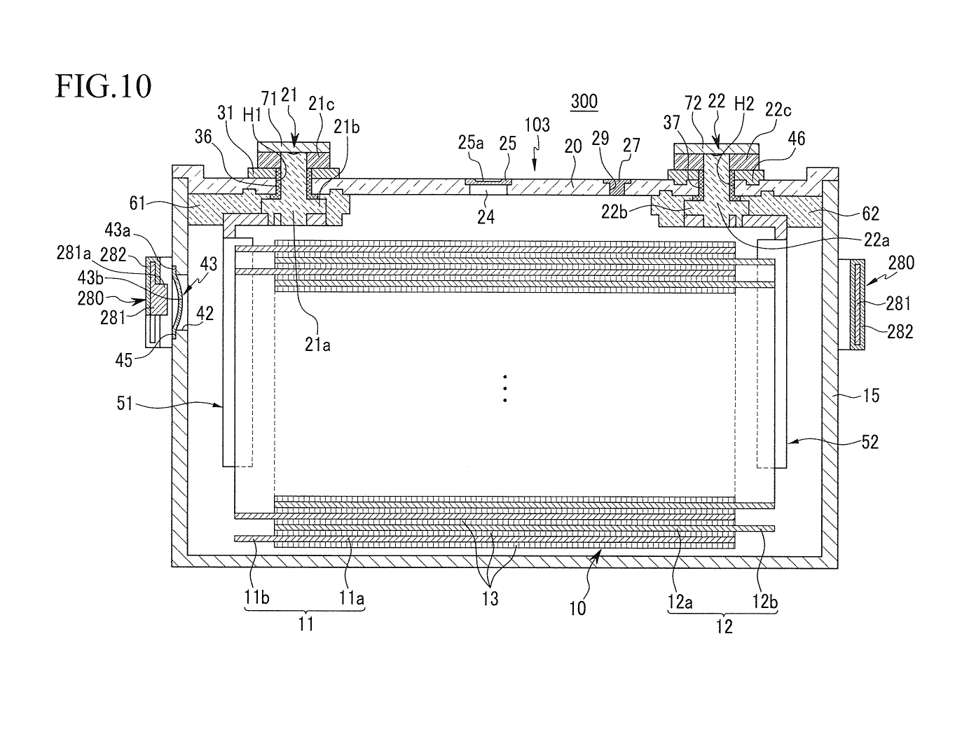

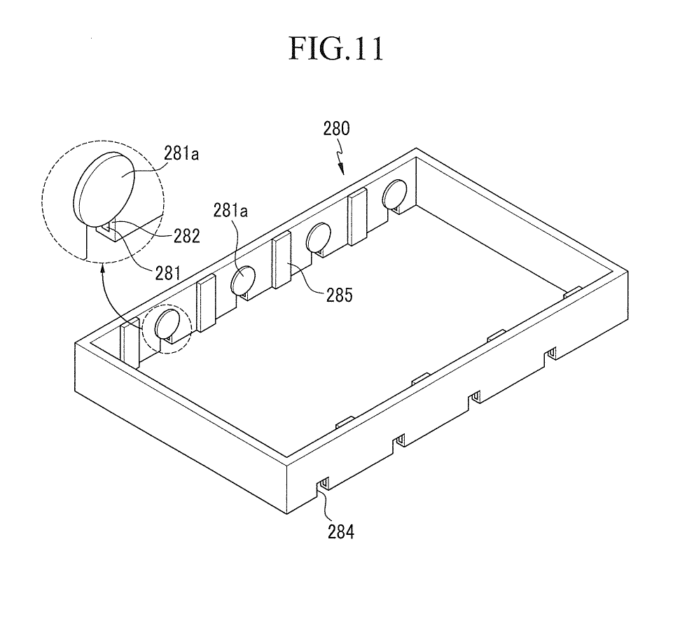

FIG. 10 is a cross-sectional view of a battery module according to a third exemplary embodiment of the present invention, and FIG. 11 is a perspective view of a module frame according to the third exemplary embodiment of the present invention.

Referring to FIG. 10 and FIG. 11, the battery module 300 includes a plurality of rechargeable batteries 103 (e.g., a battery cell and one or more additional battery cells), a bus bar 71 for electrically coupling first electrode terminals 21 and second electrode terminals 22 of the neighboring rechargeable batteries 103, and a module frame 280 wrapping external circumferences of the rechargeable batteries 103 (e.g., wrapping around a stack including the rechargeable batteries 102).

Each rechargeable battery (or battery cell) 103 includes an electrode assembly 10 including a first electrode (negative electrode) 11 and a second electrode (positive electrode) 12, a case 15 for receiving the electrode assembly 10, a cap plate 20 at (e.g., combined to) an opening of the case 15, and a first electrode terminal 21 and a second electrode terminal 22 at (e.g., installed in) the cap plate 20.

The rechargeable battery 103 according to the third exemplary embodiment has the same (or substantially the same) configuration as the rechargeable battery according to the first exemplary embodiment except for an installation configuration of the short circuit member 43 so repeated description of the features or configurations that are the same (or substantially the same) as those of the first exemplary embodiment will be omitted here.

The rechargeable batteries 103 are stacked, include the first electrode terminals 21 and the second electrode terminals 22, and are electrically coupled in series when the bus bar 71 is bonded to the terminals through welding, while the first electrode terminals 21 and the second electrode terminals 22 are alternated (e.g., alternately disposed).

A short circuit hole 42 is at (e.g., formed in) a side of a first end of the case 15, and a short circuit member 43 is at (e.g., installed in) the short circuit hole 42. The short circuit hole 42 is at (e.g., formed on) the side of the case 15 that is near the first electrode terminal 21. However, the present invention is not limited thereto, and the short circuit hole 42 can be at the side of the case 15 that is near the second electrode terminal 22. A groove 45 extended inside the short circuit hole 42 is at (e.g., formed on) the outer part of the short circuit hole 42, and it is connected to the outer side of the case 15.

The short circuit member 43 is inserted into the short circuit hole 42 and is installed to stand parallel to the side of the case 15. The short circuit member 43 has a plate shape and includes a flat edge 43a and a curved portion 43b that is curved in a convex manner toward the inside of the case 15 from the edge 43a. The edge 43a is inserted into the groove 45, it is welded to the case 15, which is electrically coupled to the positive electrode, and the edge 43a is electrically coupled to the case 15 so that the case 15 and the short circuit member 43 are electrically charged to the positive polarity.

As described herein, when the rechargeable battery 103 stands so that the first and second electrode terminals 21 and 22 face upwards, the short circuit member 43 is installed to stand in the gravity direction. For example, the short circuit member 43 may be substantially parallel to a direction of the Earth's gravitational pull. The short circuit member 43 is electrically coupled to the negatively charged short circuit connector by reversible transformation, as described above. In the present exemplary embodiment, the short circuit connector is configured with a module frame 280.

The module frame 280 is formed to be a rectangle (e.g., a square) facing (e.g., disposed to face) the side of the rechargeable battery 103, and it wraps (or partially wraps) the external circumference of the rechargeable battery (or batteries) 103.

The module frame 280 includes a short circuit conductor 281 made of an electrically conductive material and an insulating layer 282 (e.g., an electrically insulating layer) wrapping (or partially wrapping) the short circuit conductor 281. The short circuit conductor 281 includes (e.g., is made of) an electrically conductive metal, and it is disposed along the length direction of the module frame 280. In a manner similar to that of the first exemplary embodiment, the short circuit conductor 281 is electrically coupled to the negative electrode.

The insulating layer 282 is formed to wrap (e.g., at least partially wrap) the short circuit conductor 281, and a short circuit protrusion 281a protruded to the outer part of the insulating layer 282 is formed on the short circuit conductor 281. The short circuit protrusion 281a is at (e.g., formed at) a part of the short circuit conductor 281 facing the short circuit member 43 so that the short circuit protrusion 281a is exposed to directly face the short circuit member 43.

A support protrusion 285 is at (e.g., formed on) the side of the insulating layer 282 facing the case 15, and the support protrusion 285 is disposed between the short circuit protrusions 281a to separate the short circuit protrusion 281a from the case 15. The support protrusion 285 is along (e.g., formed in) the height direction of the module frame 280.

A cutout 284 is at (e.g., formed in) the module frame 280 below the short circuit conductor 281 (e.g., extended to the bottom of the module frame 280). The cutout 284 extends from the exposed short circuit protrusion 281a to reach the bottom of the module frame 280, and it has a predetermined (or preselected or set) width. When the cutout 284 is formed according to the present exemplary embodiment, moisture condensed to the exposed short circuit conductor 181 can be drawn down along the cutout 284 because of gravity. For example, the cutout 284 may be adapted to drain condensed moisture away from the short circuit conductor 281.

When the short circuit protrusion 281a is at (e.g., formed on) the short circuit conductor 281 and the support protrusion 285 is used to separate the short circuit protrusion 281a, a concavity is not formed between the short circuit member 43 and the module frame 280 so condensation and storage of moisture is prevented (or reduced).

When an internal pressure of the rechargeable battery 103 is increased, the short circuit member 43 is reversibly transformed to be convex (e.g., the short circuit member 43 may be configured to be reversibly transformed to be curved concavely away from an interior of the case 15), and when the short circuit member 43 is reversibly transformed, the short circuit member 43 is electrically coupled to the module frame 280.

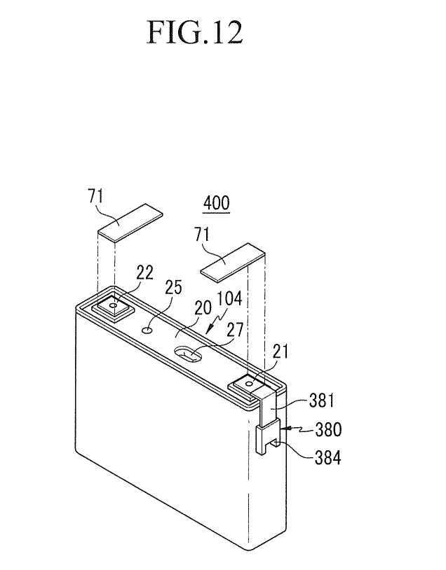

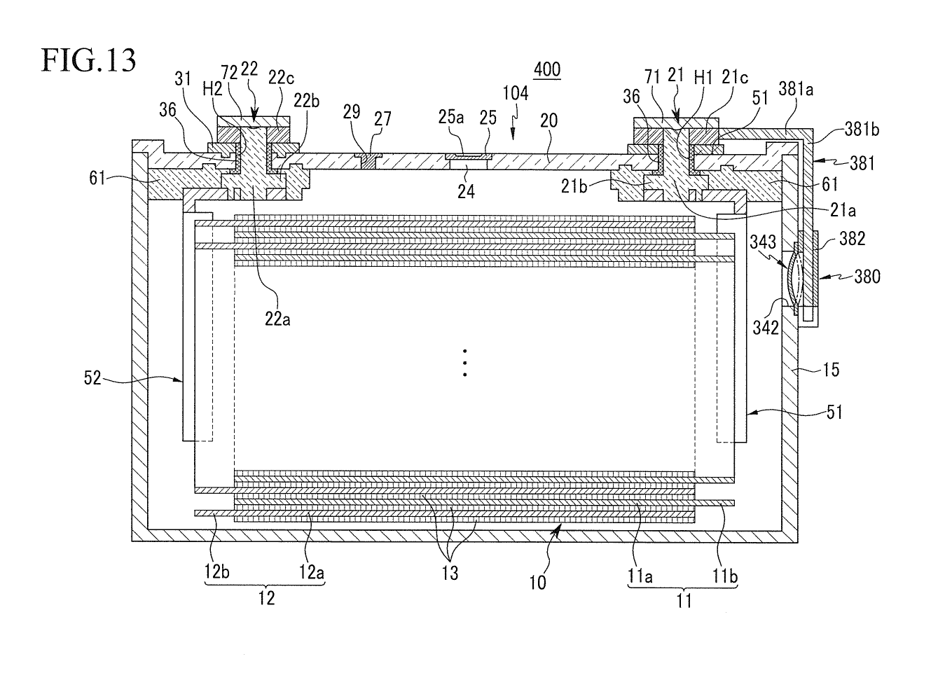

FIG. 12 is a perspective view of a battery module according to a fourth exemplary embodiment of the present invention, and FIG. 13 is a cross-sectional view of a battery module according to a fourth exemplary embodiment of the present invention.

Referring to FIG. 12 and FIG. 13, the battery module 400 includes a plurality of rechargeable batteries 104, and a bus bar 71 for electrically coupling first electrode terminals 21 and second electrode terminals 22 of the neighboring rechargeable batteries 104.

Each rechargeable battery 104 includes an electrode assembly 10 including a first electrode (negative electrode) 11 and a second electrode (positive electrode) 12, a case 15 for receiving the electrode assembly 10, a cap plate 20 at (e.g., installed in) an opening of the case 15, and a first electrode terminal 21 and a second electrode terminal 22 located (e.g., installed in) the cap plate 20.

The rechargeable battery 104 according to the fourth exemplary embodiment has the same (or substantially the same) configuration as the rechargeable battery according to the first exemplary embodiment except for an installation configuration of a short circuit connector 380, so repeated description of the features and configurations that are the same (or substantially the same) as those of the first exemplary embodiment will be omitted here.

A short circuit hole 342 is at (e.g., formed on) the side of the first end of the case 15, and a short circuit member 343 is at (e.g., installed in) the short circuit hole 342. The short circuit hole 342 is at (e.g., formed on) the side of the case 15 that is near the first electrode terminal 21. However, the present invention is not limited thereto, and the short circuit member 343 can be at the side of the case 15 that is near the second electrode terminal 22. The short circuit member 343 is inserted into the short circuit hole 342 and is installed to stand parallel to the side of the case 15.

The short circuit member 343 has (e.g., is formed with) a plate shape (e.g., a circular plate shape) having a curved portion that is curved to be convex toward the inside of the case 15. The short circuit member 343 is inserted into the groove at (e.g., formed in) the short circuit hole 342, welded to the case 15, and electrically coupled to the case 15. The case 15 is electrically charged to the positive polarity, and the short circuit member 343 is electrically charged to the positive polarity.

When the rechargeable battery 104 stands so that the first and second electrode terminals 21 and 22 face upwards, the short circuit member 343 stands in the gravity direction. For example, the short circuit member 343 may be substantially parallel to a direction of the Earth's gravitational pull. The short circuit member 343 may be electrically coupled to the short circuit connector 380, which is negatively charged, by reversible transformation.

The short circuit connector 380 includes a short circuit conductor 381 fixed to the first electrode terminal 21 through welding and an insulating layer 382 (e.g., an electrically insulating layer) wrapping (e.g., at least partially wrapping) the short circuit conductor 381. The short circuit conductor 381 includes a top plate 381a including (e.g., made of) an electrically conductive metal that is parallel to (e.g., disposed in parallel with) the cap plate 20, and a side plate 381b bent from the top plate 381a and parallel to (e.g., disposed in parallel with) the side of the case 15.

The top plate 381a is fixed to the side end of the first electrode terminal 21 through welding, and the side plate 381b is separated from the short circuit member 343 and faces (e.g., is disposed to face) the short circuit member 343. The insulating layer 382 at least partially wraps (e.g., is installed to partially wrap) the bottom of the short circuit conductor 381, and it separates the short circuit conductor 381 from the side of the case 15. At a part of the short circuit connector 380 facing toward the short circuit member 343, the insulating layer 382 is not formed and the short circuit conductor 381 is exposed. Therefore, the short circuit conductor 381 can be installed to directly face the short circuit member 343.

A cutout 384 is at (e.g., formed on) the short circuit connector 380 below the short circuit conductor 381. The cutout 384 extends from the exposed short circuit conductor 381 to reach the bottom of the short circuit connector 380, and it has a predetermined (or preselected or set) width. In some embodiments, the cutout 384 extends through a portion of the short circuit connector 380 and through a portion of short circuit conductor 381. When the cutout 384 is formed according to the present exemplary embodiment, moisture condensed to the exposed short circuit conductor 381 can be drawn down along the cutout 384 by gravity. For example, the cutout 384 may be adapted to drain condensed moisture away from the short circuit conductor 381.

When an internal pressure of the rechargeable battery 104 is increased, the short circuit member 343 is reversibly transformed to be convex toward the outer side (e.g., the short circuit member 343 may be configured to be reversibly transformed to be curved concavely away from an interior of the case 15), and when the short circuit member 343 is reversibly transformed, the short circuit member 343 is electrically coupled to the short circuit connector 380. Accordingly, when directly electrically connected, the positively charged short circuit member 343 and the negatively charged short circuit connector 380 generate a short circuit.

The short circuit connector 380 according to the present exemplary embodiment is not configured with a module frame and is instead fixedly installed in the first electrode terminal 21 of each rechargeable battery 104 to generate a short circuit in the rechargeable battery 104.

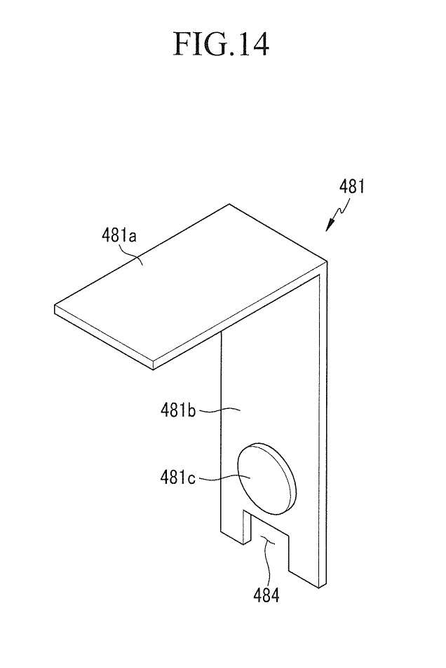

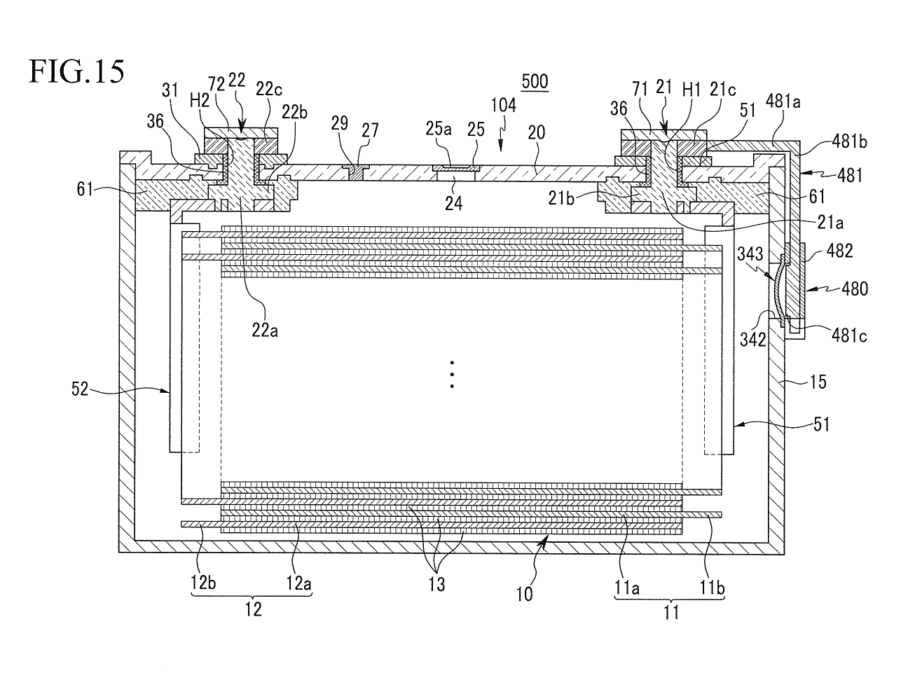

FIG. 14 is a perspective view of a short circuit conductor 481 according to a fifth exemplary embodiment of the present invention, and FIG. 15 is a cross-sectional view of a battery module according to the fifth embodiment of the present invention. Referring to FIGS. 14 and 15, the battery module 500 includes a plurality of rechargeable batteries 104, and a bus bar 71 for electrically coupling first electrode terminals 21 and second electrode terminals 22 of the neighboring rechargeable batteries 104.

Each rechargeable battery 104 includes an electrode assembly 10 including a first electrode (negative electrode) 11 and a second electrode (positive electrode) 12, a case 15 for receiving the electrode assembly 10, a cap plate 20 at (e.g., installed in) an opening of the case 15, and a first electrode terminal 21 and a second electrode terminal 22 located (e.g., installed in) the cap plate 20.

A short circuit hole 342 is at (e.g., formed on) the side of the first end of the case 15, and a short circuit member 343 is at (e.g., installed in) the short circuit hole 342. The short circuit hole 342 is at (e.g., formed on) the side of the case 15 that is near the first electrode terminal 21. However, the present invention is not limited thereto, and the short circuit member 343 can be at the side of the case 15 that is near the second electrode terminal 22. The short circuit member 343 is inserted into the short circuit hole 342 and is installed to stand parallel to the side of the case 15.

The short circuit member 343 has (e.g., is formed with) a plate shape (e.g., a circular plate shape) having a curved portion that is curved to be convex toward the inside of the case 15. The short circuit member 343 is inserted into the groove at (e.g., formed in) the short circuit hole 342, welded to the case 15, and electrically coupled to the case 15. The case 15 is electrically charged to the positive polarity, and the short circuit member 343 is electrically charged to the positive polarity.

When the rechargeable battery 104 stands so that the first and second electrode terminals 21 and 22 face upwards, the short circuit member 343 stands in the gravity direction. For example, the short circuit member 343 may be substantially parallel to a direction of the Earth's gravitational pull. The short circuit member 343 may be electrically coupled to the short circuit connector 480, which is negatively charged, by reversible transformation.

The rechargeable battery 104 according to the fifth exemplary embodiment has the same (or substantially the same) configuration as the rechargeable battery according to the first exemplary embodiment except for an installation configuration of the short circuit connector 480, so repeated description of the features and configurations that are the same (or substantially the same) as those of the first exemplary embodiment will be omitted here.

The short circuit connector 480 includes a short circuit conductor 481 fixed to the first electrode terminal 21 (e.g., through welding) and an insulating layer 482 (e.g., an electrically insulating layer) partially wrapping the short circuit conductor 481. The short circuit conductor includes a top plate 481a including (e.g., made of) an electrically conductive metal that is parallel to (e.g., disposed in parallel with) the cap plate 20, and a side plate 481b bent from the top plate 481a and parallel to (e.g., disposed in parallel with) the side of the case 15.

The top plate 481a is fixed to the side end of the first electrode terminal 21 through welding. The insulating layer 482 partially wraps (e.g., is installed to partially wrap) the bottom of the side plate 481b of the short circuit conductor 481, and a short circuit protrusion 481c protruded to the outer part of the insulating layer 482 is formed on the side plate 481b of the short circuit conductor 481. The short circuit protrusion 481c is at (e.g., formed at) a part of the short circuit conductor 481 separated from and facing the short circuit member 343 so that the short circuit protrusion 481c is exposed to directly face the short circuit member 343.

A cutout 484 is at (e.g., formed on) the short circuit connector 480 below the short circuit conductor 481. The cutout 484 extends from the exposed short circuit conductor 481 to reach the bottom of the short circuit connector 480, and it has a predetermined (or preselected or set) width. In some embodiments, the cutout 484 extends through a portion of the short circuit connector 480 and through a portion of short circuit conductor 481. When the cutout 484 is formed according to the present exemplary embodiment, moisture condensed to the exposed short circuit conductor 481 can be drawn down along the cutout 484 by gravity. For example, the cutout 484 may be adapted to drain condensed moisture away from the short circuit conductor 481.

When an internal pressure of the rechargeable battery 104 is increased, the short circuit member 343 is reversibly transformed to be convex toward the outer side (e.g., the short circuit member 343 may be configured to be reversibly transformed to be curved concavely away from an interior of the case 15), and when the short circuit member 343 is reversibly transformed, the short circuit member 343 is electrically coupled to the short circuit connector 480. Accordingly, when directly electrically connected, the positively charged short circuit member 343 and the negatively charged short circuit connector 480 generate a short circuit.

The short circuit connector 480 according to the present exemplary embodiment is not configured with a module frame and is instead fixedly installed in the first electrode terminal 21 of each rechargeable battery 104 to generate a short circuit in the rechargeable battery 104.

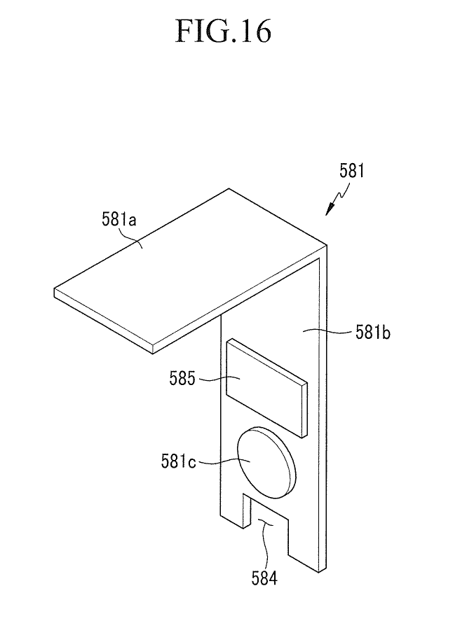

FIG. 16 is a perspective view of a short circuit conductor 581 according to a sixth exemplary embodiment of the present invention. A battery module according to the sixth exemplary embodiment has the same (or substantially the same) configuration as the battery module according to the fifth exemplary embodiment except for an installation configuration of the short circuit conductor 581, so repeated description of the features and configurations that are the same (or substantially the same) as those of the first exemplary embodiment will be omitted here.

The short circuit conductor 581 is fixed to the first electrode terminal 21 (e.g., through welding). The short circuit conductor 581 includes a top plate 581a including (e.g., made of) an electrically conductive metal that is parallel to (e.g., disposed in parallel with) the cap plate 20, and a side plate 581b bent from the top plate 581a and parallel to (e.g., disposed in parallel with) the side of the case 15.

The top plate 581a is fixed to the side end of the first electrode terminal 21 through welding. A short circuit protrusion 581c is at (e.g., formed on) the side plate 581b of the short circuit conductor 581. The short circuit protrusion 581c is at (e.g., formed at) a part of the short circuit conductor 581 separated from and facing the short circuit member 343 so that the short circuit protrusion 581c is exposed to directly face the short circuit member 343.

A support protrusion 585 is at (e.g., formed on) the side of the side plate 581b of the short circuit conductor 581 facing the case 15, and the support protrusion 585 is between the short circuit conductor 581 and the case 15 to separate the short circuit protrusion 581c from the case 15. The support protrusion 585 is along (e.g., formed in) the width direction of the short circuit conductor 581.

When the short circuit protrusion 581c is at (e.g., formed on) the short circuit conductor 581 and the support protrusion 585 is used to separate the short circuit protrusion 581a, a concavity is not formed between the short circuit member 343 and the short circuit protrusion 581c, so condensation and storage of moisture is prevented (or reduced).

A cutout 584 is located (e.g., formed) below the short circuit protrusion 581c. The cutout 584 extends to reach the bottom of the short circuit conductor 581, and it has a predetermined (or preselected or set) width. In some embodiments, the cutout 584 extends through a portion of the short circuit connector 581. When the cutout 584 is formed according to the present exemplary embodiment, moisture condensed to the exposed short circuit conductor 581 can be drawn down along the cutout 584 by gravity. For example, the cutout 584 may be adapted to drain condensed moisture away from the short circuit conductor 581.

When an internal pressure of the rechargeable battery 104 is increased, the short circuit member 343 is reversibly transformed to be convex toward the outer side (e.g., the short circuit member 343 may be configured to be reversibly transformed to be curved concavely away from an interior of the case 15), and when the short circuit member 343 is reversibly transformed, the short circuit member 343 is electrically coupled to the short circuit conductor 581. Accordingly, when directly electrically connected, the positively charged short circuit member 343 and the negatively charged short circuit conductor 581 generate a short circuit.

The short circuit conductor 581 according to the present exemplary embodiment is not configured with a module frame, but is instead fixedly installed in the first electrode terminal 21 of each rechargeable battery 104 to generate a short circuit in the rechargeable battery 104.

In the above described embodiments, each battery module may include a plurality of rechargeable batteries (e.g., a plurality of battery cells). However, the present invention is not limited thereto. For example, in each embodiment of the present invention, the battery module can include a single battery cell (e.g., see FIG. 12, where the bus bars 71 can be replaced with electrode terminals, such as electrode terminals 72 and 73 of FIG. 1) instead of a plurality of battery cells.

While certain embodiments of the present invention have been described, it is to be understood that the invention is not limited the disclosed embodiments, but, on the contrary, is intended to cover various modifications and equivalent arrangements included within the spirit and scope of the appended claims, description, and drawings, and equivalents thereof.

What is claimed is:

1. A battery module comprising:
a battery cell comprising:
an electrode assembly comprising a first electrode and a second electrode;
a case housing the electrode assembly; and
a short circuit member at a side of the case and electrically coupled to the second electrode; and
a short circuit connector comprising a short circuit conductor electrically coupled to the first electrode, the short circuit member being spaced from the short circuit conductor and being configured to change shape to contact the short circuit conductor, and the short circuit connector having a cutout below the short circuit conductor.

2. The battery module of claim 1, wherein the cutout is adapted to drain condensed moisture away from the short circuit conductor.

3. The battery module of claim 1, wherein the short circuit conductor comprises a short circuit protrusion protruding toward the short circuit member.

4. The battery module of claim 3, further comprising a support protrusion on a side of the short circuit connector facing toward the battery cell to provide a gap between the short circuit protrusion and the battery cell.

5. The battery module of claim 1, wherein the short circuit connector further comprises an insulating layer at least partially wrapping the short circuit conductor.

6. The battery module of claim 5, the insulating layer having an opening to expose the short circuit conductor to the short circuit member.

7. The battery module of claim 6, wherein the cutout extends from the bottom of the insulating layer to the opening.

8. The battery module of claim 5, wherein the cutout extends through a portion of the insulating layer and through a portion of the short circuit conductor.

9. The battery module of claim 1, wherein the case has a short circuit hole, and the short circuit member is at the short circuit hole.

10. The battery module of claim 9, wherein the short circuit hole is surrounded by a groove, and the short circuit member has a flat edge inserted into the groove.

11. The battery module of claim 1, wherein the short circuit member comprises a flat edge and a curved portion curved convexly toward the interior of the case, the curved portion being configured to be reversibly transformed to be curved concavely away from the interior of the case to contact the short circuit conductor.

12. The battery module of claim 1, wherein the short circuit member is substantially parallel to a side of the case.

13. The battery module of claim 1, wherein the short circuit member is substantially parallel to a direction of the Earth's gravitational pull.

14. The battery module of claim 1, wherein the second electrode and the short circuit member are each electrically coupled to the case and the short circuit member is configured to change shape to contact the short circuit conductor to electrically couple the first electrode to the second electrode through the case.

15. The battery module of claim 1, further comprising an additional battery cell.

16. The battery module of claim 15, wherein the battery cell and the additional battery cell are in a stack, and the short circuit connector wraps around the stack.

17. The battery module of claim 16, wherein the additional battery cell comprises a first electrode and a second electrode, and a first module terminal is electrically coupled to the first electrode of the additional battery cell at a first end of the stack and a second module terminal is electrically coupled to the second electrode of the battery cell at a second end of the stack.

18. The battery module of claim 17, wherein the short circuit conductor is electrically coupled to the second module terminal of the battery cell at the second end of the stack.

19. The battery module of claim 15, wherein the additional battery cell comprises a short circuit member facing the short circuit conductor.

20. The battery module of claim 1, wherein the first electrode is electrically coupled to a first electrode terminal by a first electrode lead tab and the second electrode is electrically coupled to the second electrode terminal by a second electrode lead tab, and at least one of the first electrode lead tab or the second electrode lead tab comprises a fuse having a smaller cross-section than a remaining portion of the first electrode lead tab or a remaining portion of the second electrode lead tab.
